(19) United States
(12) Patent Application Publication
(10) Pub. No.: US 2023/0158571 A1
(43) Pub. Date: May 25, 2023

(54) METHOD FOR THE ABRUPT DISPLACEMENT OF A CONTINUOUS ENERGY BEAM, AND MANUFACTURING DEVICE

(71) Applicant: TRUMPF Laser- und Systemtechnik GmbH, Ditzingen (DE)

(72) Inventors: Wilhelm Meiners, Aachen (DE); Philipp Wagenblast, Leonberg (DE); Valentin Blickle, Stuttgart (DE); Matthias Allenberg-Rabe, Ludwigsburg (DE); Jonas Gruenewald, Munich (DE)

(21) Appl. No.: 18/152,173

(22) Filed: Jan. 10, 2023

Related U.S. Application Data
(63) Continuation of application No. PCT/EP2021/070414, filed on Jul. 21, 2021.

(30) Foreign Application Priority Data
Jul. 21, 2020 (DE) 20 2020 107 409.1
Oct. 9, 2020 (DE) 10 2020 006 217.2
Nov. 2, 2020 (DE) 10 2020 128 807.7
Nov. 24, 2020 (DE) 10 2020 131 033.1

(51) Int. Cl. B22F 10/366; B22F 12/49; B22F 12/41; B33Y 10/00; B33Y 30/00

(52) U.S. Cl. CPC B22F 10/366; B22F 12/49; B22F 12/41; B33Y 10/00; B33Y 30/00; B22F 10/28

(57) ABSTRACT

A method for displacing a continuous energy beam includes emitting a continuous energy beam in a direction of a powder material and displacing the energy beam by overlaying an optical deflection of the energy beam using of a deflection device and a mechanical deflection of the energy beam using of a scanner device. The mechanical deflection is configured to position the energy beam at a plurality of irradiation positions, and the optical deflection is configured to deflect the energy beam around each of the irradiation positions within a beam region of the deflection device onto at least one beam position in a sequence of beam positions. The optical deflection and the mechanical deflection are controlled such that the energy beam successively scans subsequences with an abrupt change of the optical deflection such that two spatially separated subsequences are successively adopted by the energy beam.

### CROSS REFERENCE TO RELATED APPLICATIONS

This application is a continuation of International Application No. PCT/EP2021/070414 (WO2022/018150 A1), filed on Jul. 21, 2021, and claims benefit to German Patent Applications No. DE 20 2020 107 409.1, filed on Jul. 21, 2020, DE 10 2020 006 217.2, filed on Oct. 9, 2020, DE 10 2020 128 807.7, filed on Nov. 2, 2020 and DE 10 2020 131 033.1, filed on Nov. 24, 2020. The aforementioned applications are hereby incorporated by reference herein.

### FIELD

The present invention relates to a method for displacing a continuous energy beam along an irradiation path formed by a sequence of beam positions. Further, the invention relates to an apparatus for additive manufacturing of component parts from a powder material.

### BACKGROUND

Laser-based additive manufacturing of in particular metal or ceramic component parts is based on solidifying a starting material present in powdered form by irradiating it with laser light. During the additive manufacture of component parts from a powder material, an energy beam such as a laser beam is typically displaced to predetermined irradiation positions within a work region—in particular along a predetermined irradiation path—in order to locally solidify powder material arranged in the work region. In particular, this is repeated layer-by-layer in powder material layers successively arranged in the work region in order to ultimately obtain a three-dimensional component part made of solidified powder material.

Additive manufacturing methods are also known as powder bed-based methods for producing component parts in a powder bed, selective laser melting, selective laser sintering, laser metal fusion (LMF), direct metal laser melting (DMLM), laser net shaping manufacturing (LNSM), and laser engineered net shaping (LENS). Accordingly, the manufacturing devices disclosed herein are configured in particular to carry out at least one of the aforementioned additive manufacturing methods.

The concepts disclosed herein can be used, inter alia, in machines for (metallic) 3-D printing. An exemplary machine for producing three-dimensional products is disclosed in EP 2 732 890 A1. The advantages of additive manufacturing are generally the simple production of complex and individually creatable component parts. In particular defined internal structures and/or structures with an optimized flow of forces can be implemented here.

Parameters such as intensity/energy, beam diameter, scanning speed, dwell time at one location on part of the energy beam and parameters such as grain size distribution and chemical composition on part of the powder material type are included in the interaction of the energy beam with the powder material. Further, thermal parameters which inter alia arise from the interaction zone surroundings are incorporated in the energy input. Thus, already solidified regions of already produced layers of the component part and already solidified regions of the same layer adjacent to the interaction zone dissipate the introduced heat better than powder material that has not (or not yet) fused and that may be situated below a structure of the component part or in the same layer. Should molten powder material overheat, droplets may detach/splash from the melt, as a result of which these may generally impair the product quality and the production process.

### SUMMARY

In an embodiment, the present disclosure provides a method for displacing a continuous energy beam along an irradiation path formed by a sequence of beam positions and provided to solidify a powder material in a powder layer within a work region of a manufacturing device. The method includes the steps of emitting the continuous energy beam in a direction of the powder material so as to form a layer of a component part within the scope of an additive manufacturing method, and displacing the energy beam within the work region by overlaying an optical deflection of the energy beam using of a deflection device and a mechanical deflection of the energy beam using of a scanner device. The mechanical deflection is configured to position the energy beam at a plurality of irradiation positions arranged within the work region and substantially spanning the work region, and the optical deflection is configured to deflect the energy beam around each of the irradiation positions within a beam region of the deflection device onto at least one beam position of the sequence of beam positions. The optical deflection and the mechanical deflection are changed simultaneously or successively so as to scan the sequence of beam positions using the energy beam. In addition the deflection device and the scanner device are controlled such that the energy beam successively scans subsequences, each subsequence comprising at least one beam position of the sequence of beam positions, with the energy beam skipping a region between subsequent subsequences by way of an abrupt change of the optical deflection such that two spatially separated subsequences are successively adopted by the energy beam.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic spatial illustration of a manufacturing device for additive manufacturing;

FIG. 2 shows a schematic illustration of an exemplary beam path of the manufacturing device;

FIGS. 3A,3B and 3C show sketches for explaining an acousto-optic deflection within the scope of additive manufacturing;

FIG. 4 shows a sketch for explaining electro-optic deflection within the scope of additive manufacturing;

FIGS. 5A, 5B and 5C show sketches relating to linear scanning processes on the basis of optical deflections;

FIG. 6 shows a sketch for elucidating the simultaneous exposure of scanning vectors in irradiation zones;

FIGS. 7A, 7B, 7C and 8 show sketches for elucidating irradiation paths based on mechanical deflection and optical deflection;

FIGS. 9A and 9B show sketches of irradiation paths which by means of a lateral optical deflection use a broadening of a “mechanical” scanning vector, and

FIGS. 10A, 10B, 10C and 10D show sketches regarding the additive manufacture of delicate structures.

### DETAILED DESCRIPTION

One aspect of this disclosure is to enable irradiation concepts and, in particular, irradiation paths which go beyond the limitations of a conventional scanner device. In particular, overheating of the molten powder should be prevented independently of the course of the irradiation path, with the intention being that this is ensured, where possible, even when high energies are introduced. Further, a problem consists of specifying methods for flexibly adjustable displacement of a continuous energy beam along an irradiation path and an apparatus for additive manufacturing of component parts from a powder material for the implementation of such methods.

In one aspect, a method for displacing a continuous energy beam along an irradiation path formed by a sequence of beam positions and provided to solidify a powder material in a powder layer within a work region of a manufacturing device includes the following steps:

radiating the continuous energy beam onto the powder material in order to form a layer of a component part within the scope of an additive manufacturing method; and

displacing the energy beam within the work region by overlaying an optical deflection of the energy beam by means of a deflection device and a mechanical deflection of the energy beam by means of a scanner device, wherein
the mechanical deflection is designed to position the energy beam at a plurality of irradiation positions arranged within the work region, with the irradiation positions substantially spanning the work region, and
the optical deflection is designed to deflect the energy beam around each of the irradiation positions within a beam region of the deflection device onto at least one beam position of the sequence of beam positions,

wherein the optical deflection and the mechanical deflection are changed simultaneously or successively in order to scan the sequence of beam positions by means of the energy beam.

In general, the beam region is specified herein by a maximum extent of the optical deflection of the deflection device.

In a further aspect, the sketched-out method may further comprise the step of:

controlling the deflection device and the scanner device such that

the energy beam successively scans subsequences, which each comprise at least one beam position of the sequence of beam positions of the irradiation path, with the energy beam skipping a region between the spaced apart subsequences by way of an abrupt change of the optical deflection such that spatially separated, in particular thermally decoupled subsequences are successively adopted by the energy beam.

In general, the sketched-out method may, in a further aspect, further comprise the step of abruptly displacing the energy beam at a plurality of discrete beam positions.

In a further aspect, a manufacturing device for additive manufacturing of a component part from a powder material provided in a work region comprises:
a beam producing device configured to produce a continuous energy beam for irradiating the powder material,
a scanner device configured for a mechanical deflection to position the energy beam at a plurality of irradiation positions, with the irradiation positions substantially spanning the work region,
a deflection device configured for an optical deflection to deflect the energy beam around each of the irradiation positions within a beam region onto at least one beam position of the sequence of beam positions, and
a control device operatively connected to the scanner device and the deflection device and configured to control the deflection device and the scanner device such that the optical deflection and the mechanical deflection are changed simultaneously or successively in order to scan an irradiation path formed by a sequence of the beam positions by way of the continuous energy beam, with the irradiation path being provided for solidifying the powder material in a powder layer within the work region.

In the sketched-out manufacturing device, the control device in a further aspect may further be configured to control the deflection device and the scanner device such that the energy beam successively scans subsequences, which each comprise at least one beam position of the sequence of beam positions of the irradiation path, with the energy beam skipping a region between the spaced apart subsequences by way of an abrupt change of the optical deflection such that spatially separated, in particular thermally decoupled subsequences are successively adopted by the energy beam.

In some developments of the method, at least one of
a number of subsequences along the irradiation path,
a number of beam positions in one of the subsequences, and
a spatial distance between successively adopted subsequences

can be determined considering/ensuring the dissipation of the energy introduced into the subsequences by means of the energy beam, in particular a limitation of the irradiation duration or the energy introduced into the subsequences by means of the energy beam.

In some developments of the method, the deflection device and the scanner device may be controlled in such a way that adjacent beam positions of the irradiation path are not adopted successively in time.

In some developments of the method and/or the manufacturing device, the deflection device may comprise an optical material, more particularly a transparent material, in a passage region provided for the energy beam, said material having optical properties which can be adjusted to bring about the optical deflection. The deflection device may comprise a crystal in particular, within which an acoustic wave with an acoustic wavelength is formed or a refractive index or a refractive index gradient is set in order to bring about the optical deflection.

In some developments, the method may comprise the following further steps:
exciting an acoustic wave with an acoustic wavelength in the optical material for the purposes of forming an acousto-optic diffraction grating,
radiating the energy beam onto the passage region,
diffracting the majority of the energy beam, in particular at least 80% and preferably at least 90% of the energy beam, into a first order of diffraction at a diffraction angle at the acousto-optic diffraction grating,
guiding the diffracted energy beam to a first of the beam positions, and
changing the optical deflection of the energy beam by changing the acoustic wavelength, with discrete change of the acoustic wavelength in particular being undertaken for the abrupt change of the acousto-optic deflection such that the region between the spaced apart subsequences, and in particular at least one beam position of the irradiation path situated spatially between the subsequences, is skipped by the energy beam.

In some developments, the method may comprise the following further steps:
exciting an acoustic wave, in particular a standing wave, with at least two acoustic wavelengths in the optical material for the purposes of forming an acousto-optic diffraction grating,
radiating the energy beam onto the passage region,
diffracting the majority of the energy beam, in particular at least 80% and preferably at least 90% of the energy beam, into a first order of diffraction at a diffraction angle at the acousto-optic diffraction grating,
guiding the diffracted energy beam to at least one first of the beam positions and one second of the beam positions, and
preferably changing the optical deflection of the energy beam by changing at least one of the acoustic wavelengths, in particular continuously or in discrete steps.

This is advantageous in that two beam positions in the deflection direction of the deflection device can be exposed simultaneously without the region between the two beam positions being exposed to the laser beam. Moreover, the distance of the two beam positions from one another can be changed by changing one of the acoustic wavelengths. Additionally, the intensity distribution of the diffracted energy beam between the first and the second of the beam positions can be set by setting the amplitude of the two acoustic waves. An acoustic wave with more than two acoustic wavelengths is also conceivable such that the diffracted energy beam can simultaneously be guided to more than two positions. Thus, the two or more positions of the energy beam may form a line of overlapping and/or spaced apart beam positions.

In general, an advantage of the beam displacement using an AOD is that a region between start position and end position is not exposed to the laser beam as a result of changing the acoustic wavelengths in discrete steps since the periodic changes in the refractive index temporally merge into one another substantially without forming a diffractive transition behavior. Accordingly, the energy input is restricted to the start position and the end position; this corresponds to an abrupt change in the acousto-optic deflection.

In some developments of the method, spatially non-adjacent beam positions of the irradiation path can be adopted successively in time. In addition or as an alternative, the spaced apart subsequences can be arranged spaced apart from one another in the work region by at least one diameter of the energy beam or by at least 50% of the diameter of the energy beam or by at least 1.5- to 2-times the diameter of the energy beam. Further additionally or in another alternative, regions of the work region which are selected from the group of regions comprising a not yet irradiated region of the work region, a region of the work region not to be irradiated, and an already irradiated region of the work region can be skipped.

In some developments of the method, while the scanner device is controlled such that the mechanical deflection positions the energy beam at an irradiation position, the deflection device can be controlled such that the energy beam successively adopts the beam positions of subsequences which completely cover the beam region of the corresponding irradiation position, and in particular a specified beam shape of the beam region.

In some developments of the method, while the scanner device is controlled such that the mechanical deflection positions the energy beam continuously at a sequence of irradiation positions, the deflection device can be controlled such that the energy beam successively adopts the beam positions of subsequences which partially or completely cover the beam region of the corresponding irradiation position, and in particular a specified beam shape of the beam region.

In some developments of the method, the deflection device can be controlled such that the energy beam at one irradiation position of the plurality of irradiation positions is displaced to a plurality of beam positions within a beam region in order to form a beam profile of the beam region during the production of a component part, and the energy beam is displaced abruptly to the plurality of discrete beam positions. In this case, the energy beam may skip spatially adjacent beam positions in the beam region in particular and in particular only adopt spatially non-adjacent beam positions in the beam region successively in time.

In some developments, the method can further comprise the following step:

radiating-in the energy beam by virtue of the scanner device being controlled in such a way that the energy beam is positioned along a subsequence of irradiation positions in accordance with a scanning path and the deflection device simultaneously being controlled in such a way that the energy beam jumps back and forth between beam positions of a two-dimensional arrangement of beam positions, in particular between beam positions arranged transversely to the scanning path.

In some developments of the method, the irradiation path may comprise at least one irradiation zone in which a plurality of subsequences of irradiation positions are defined in the form of adjacent, at least partially parallel scanning vectors, in particular of the same length, wherein the method may further comprise the following step:

radiating-in the energy beam by virtue of the scanner device being controlled in such a way that the irradiation position is displaced along a first scanning vector of the scanning vectors and the deflection device simultaneously being controlled in such a way that the energy beam jumps back and forth between the first scanning vector of the scanning vectors and at least one further scanning vector of the scanning vectors.

In some developments, the method can further comprise the following step:

radiating-in the energy beam by virtue of the scanner device being controlled in such a way that the irradiation position is displaced along a subsequence of irradiation positions in accordance with a scanning direction and the deflection device simultaneously being controlled in such a way that the energy beam jumps, in and counter to the scanning direction, between beam positions arranged along the subsequence.

In some developments of the method, the irradiation path may have at least two irradiation zones, in each of which a plurality of subsequences of irradiation positions are defined in the form of adjacent, at least partially parallel scanning vectors of the same length, wherein, in the method for displacing the energy beam, the scanner device is controlled in such a way that the energy beam is positioned along a first scanning vector of the scanning vectors in a first of the irradiation zones and the deflection device simultaneously is controlled in such a way that the energy beam jumps back and forth between the first of the scanning vectors in the first of the irradiation zones and at least one further scanning vector of the scanning vectors of a further one of the irradiation zones.

In some developments of the method, the irradiation path may have at least one irradiation zone or delicate structure, in each of which a plurality of subsequences of irradiation positions are defined in the form of adjacent, at least partially parallel scanning vectors of the same or different length, wherein,

to displace the energy beam, the deflection device is controlled in such a way that the energy beam is positioned along a first scanning vector of the scanning vectors in the irradiation zone or delicate structure.

By way of example, this allows the use of a scanner device with a low dynamic response without this leading to a substantial limitation in the productivity of the manufacturing device.

In a development of this method, to displace the energy beam, the deflection device can be controlled in such a way that the energy beam jumps back and forth between the first scanning vector and at least one further scanning vector of the scanning vectors and that the energy beam is positioned along the at least one further scanning vector.

By way of example, this renders possible the use of an energy beam whose energy input is above a limit value (e.g., the power of a laser beam) as usually predetermined for a powder material type (grain size distribution, chemical composition of the powder material) in the case of continuous scanning with a beam diameter for a given scanning speed. By way of example, this may allow the laser beam to be guided along two thermally decoupled scanning vectors as a result of jumping back and forth, and so two melt tracks are formed simultaneously in the powder bed and the laser beam can be operated with twice the power of the aforementioned limit value in comparison with the case where only one melt track is formed. The productivity of the manufacturing device is doubled in this example.

In some developments of the manufacturing device, the deflection device can be configured to abruptly displace the energy beam to a plurality of discrete beam positions.

In some developments of the manufacturing device, the control device may be configured to control the scanner device and the deflection device in accordance with the methods disclosed herein.

In some developments of the manufacturing device, the scanner device may comprise at least one scanner, in particular a galvanometer scanner, a piezo-scanner, a polygon scanner, a MEMS scanner and/or a work head that is displaceable relative to the work region. In addition or as an alternative, the deflection device may comprise at least one electro-optic deflector and/or acousto-optic deflector, preferably two electro-optic or acousto-optic deflectors oriented in non-parallel fashion, in particular perpendicular to one another.

Further, the deflection device may comprise at least one acoustic-optic deflector with an optical material, such as a crystal, and an exciter for producing acoustic waves in the optical material, and/or the beam producing device may be in the form of a continuous wave laser.

In some developments of the method, the deflection device may comprise an optical material, more particularly a transparent material, such as a crystal in a passage region provided for the energy beam, said material having optical properties which can be adjusted to bring about the optical deflection.

In some developments, the method can further comprise:
exciting an acoustic wave with an acoustic wavelength in the optical material for the purposes of forming an acousto-optic diffraction grating,
radiating the energy beam onto the passage region,
diffracting the majority of the energy beam, in particular at least 80% and preferably at least 90% of the energy beam, into a first order of diffraction at a diffraction angle at the acousto-optic diffraction grating,
guiding the diffracted energy beam to a first of the beam positions (17), and
changing the optical deflection of the energy beam by changing the acoustic wavelength. In this case, changing the acoustic wavelength may change the diffraction angle of the first order of diffraction in such a way that the diffracted energy beam is guided to a second of the beam positions. In particular, the acoustic wavelength may be changed incrementally about a wavelength change such that the energy beam successively introduces energy at beam positions of the irradiation path, with energy being introduced simultaneously at two beam positions during a transition time, within which two acoustic wavelengths are present in the passage region. Further, the wavelength change in this case may bring about a change in the diffraction angle such that spatially adjacent beam positions of the irradiation path or spatially spaced apart, in particular thermally decoupled beam positions are scanned successively in time by the energy beam.

In some developments, the deflection device may be controlled in such a way that at least one beam position is skipped when scanning the sequence of beam positions, with the skipped beam position being scanned at a subsequent time.

In some developments, the method can further comprise:
applying a voltage to the optical material to set a refractive index or a refractive index gradient,
radiating the energy beam onto the passage region,
deflecting the energy beam on the basis of the set refractive index or refractive index gradient,
guiding the deflected energy beam to a first of the beam positions, and
changing the optical deflection of the energy beam by changing the applied voltage.

Herein, an optical deflection is understood to mean a deflection optically induced by means of a deflection device. An example of an optical deflection is a variation of an optical parameter of an optical medium in the beam path, which brings about a change in the beam path. The optical deflection differs from a mechanical deflection, which is understood to be a deflection mechanically induced by means of a scanner device. An example of a mechanical deflection is a mechanically controlled reflective deflection of a laser beam.

Aspects described herein are based in part on the discovery that a positioning of the energy beam on a powder bed of an additive manufacturing device may be divided into

a) a mechanical deflection by means of one or more sluggish axes, which have a low acceleration with usually a large range of movement, and

b) an optical deflection by means of one or more dynamic axes, which have a greater acceleration with usually a smaller range of movement.

Within the scope of additive manufacturing, a deflection about sluggish axes is usually implemented by positioning mirrors in a scanner device and is referred to herein as a mechanical deflection. By way of example, scanner devices are operated with scanning speeds during the process of several hundred millimeters per second, with maximum scanning speeds of the order of m/s (for example, up to 30 m/s). Thus, galvanometer scanners have scanning speeds of, e.g., 1 m/s to 30 m/s.

A deflection about dynamic fast axes can be implemented by influencing optical properties of optical elements/materials in the beam path of the energy beam in the manufacturing device. This is referred to as optical deflection herein. By way of example, this can be brought about by acousto-optic or electro-optic effects in an optical crystal. The optical crystal interacts with the energy beam and influences the beam path very quickly, and so changeover times between beam positions of the order of 1 μs and corresponding changeover speeds depending on the extent of the jump of up to several 1000 m/s (e.g., 10 000 m/s and more) become possible. A deflection angle of the energy beam, for example by means of an acousto-optic deflector (AOD) or an electro-optic deflector (EOD)—as examples of an optical solid-state deflector—can be set by varying the acoustic excitation frequency or an applied voltage within a deflection range about a central value. Maximum scanner accelerations of AODs and EODs can be of the order of 160 000 rad/s². Depending on the dimensioning of the additive manufacturing device, this yields scanner accelerations of, e.g., 80 000 m/s² (depending on the respective work distance from the AOD/EOD).

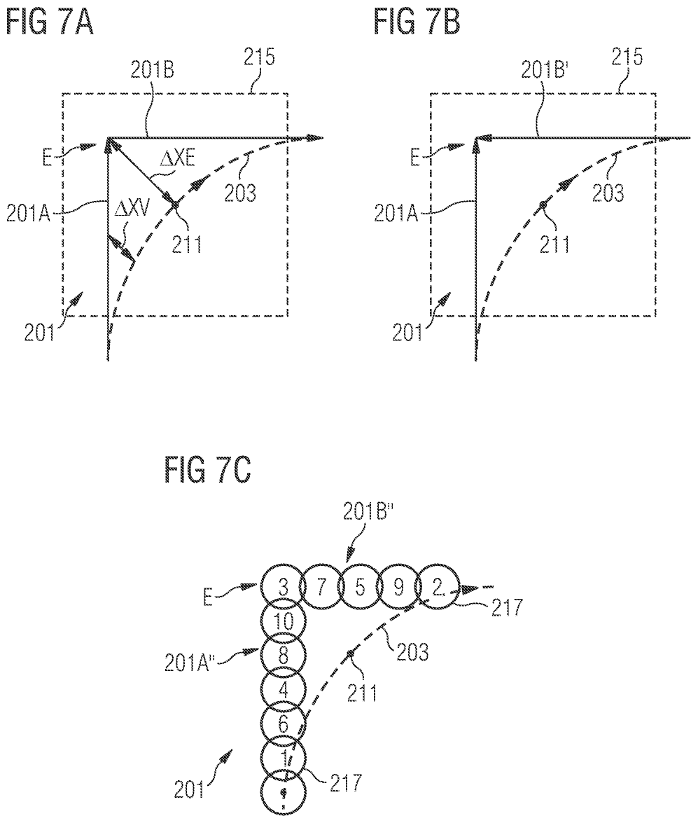

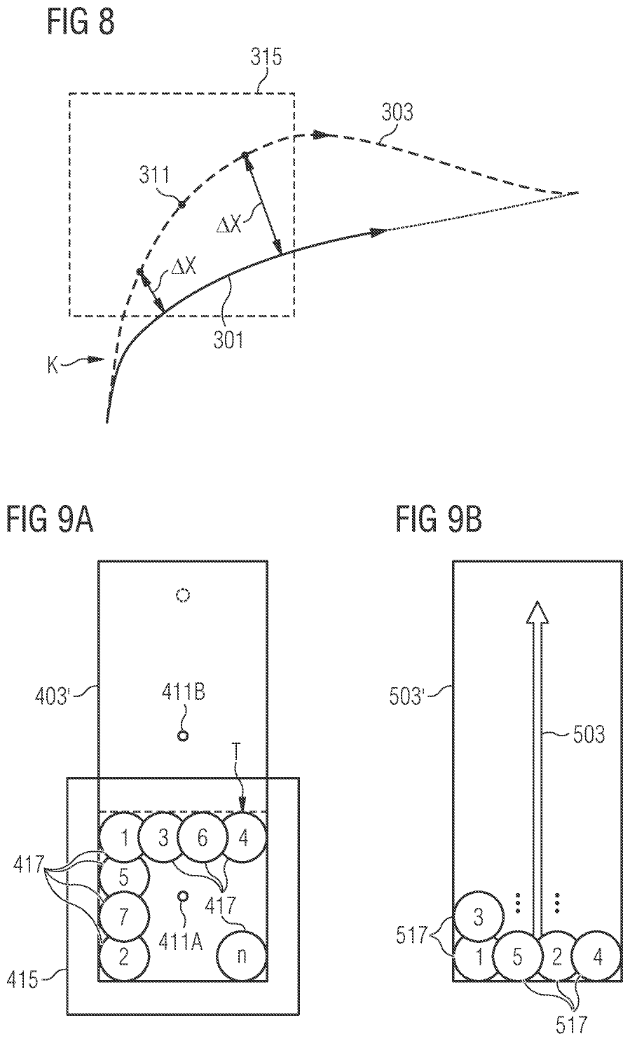

The division within the scope of the deflection of an energy beam proposed herein may enable irradiation concepts which allow the avoidance of disadvantages which may occur, inter alia, in the case of movements with significant changes in direction by means of a purely mechanical deflection; see, inter alia, the exemplary explanations relating to an angular irradiation path in the context of FIGS. 7A to 8.

Further, the inventors have recognized that the dynamic (fast) axis can further be used to abruptly displace the position of the energy beam. By way of example, within the scope of the manufacture of tapering structures, this allows segments of the irradiation path to always be scanned in the direction of the taper; see, inter alia, the exemplary explanations relating to an angular irradiation path in the context of FIG. 7B.

Further, the inventors have recognized that the option of an instantaneous abrupt optical deflection may generally allow the use of an energy input by way of the energy beam (e.g., a power value of a laser beam) which is above a limit value as usually given for a powder material type (determined, inter alia, by a grain size distribution and a chemical composition of the powder material) in the case of continuous scanning with a beam diameter in the case of a given scanning speed and component part geometry to be produced.

To this end, a “spatially local” exposure in a type of pulsed operation can be undertaken by way of the dynamic (fast) axis provided by the optical deflection. In this way, it is possible to expose, in particular, delicate component parts and sections with a poor heat dissipation (for example, in the region of protrusions or pointed structures) by way of the “spatially locally pulsed” energy beam, as a result of which it is possible to obtain a better component part quality. Such “spatially locally pulsed” irradiation using a continuous energy beam (e.g., a cw laser beam) can increase the productivity of the additive manufacturing process, especially in comparison with manufacturing using a pulsed laser beam.

Using “spatially locally pulsed” irradiation, it is possible for example to process two or more sections to be processed in pulsed fashion, which sections are located within the (small) range of movement of the optical deflection (e.g., up to a few millimeters or even centimeters in the case of an acousto-optic deflector, depending on the position of same in the beam path). By way of example, a point can be exposed in a first section; then, it is possible to carry out a jump to a second (different) section and a point can be exposed there; subsequently, following a jump back to the (original) first section, a further point, which is adjacent to or spaced apart from the first point, can be exposed. Expressed differently, spatially non-adjacent beam positions of an irradiation path are adopted successively in time.

In this respect, see, inter alia, the exemplary explanations regarding the jumping along an irradiation path (explained in the context of FIG. 5B), regarding the jumping within one hatch or between a plurality of hatches (irradiation zones) (explained in the context of FIG. 6), and regarding the jumping in the case of a section of an irradiation path with an angular form (explained in the context of FIG. 7C).

Further, the mechanically scanned region can be broadened when the optical deflection is used. To this end, the optical deflection can be implemented laterally in relation to a main scanning direction of the energy beam on the powder bed, the main scanning direction being provided by the mechanical deflection. Optionally, the lateral deflection can also consider thermal aspects of overheating in this case, as explained in the context of FIGS. 9A and 9B.

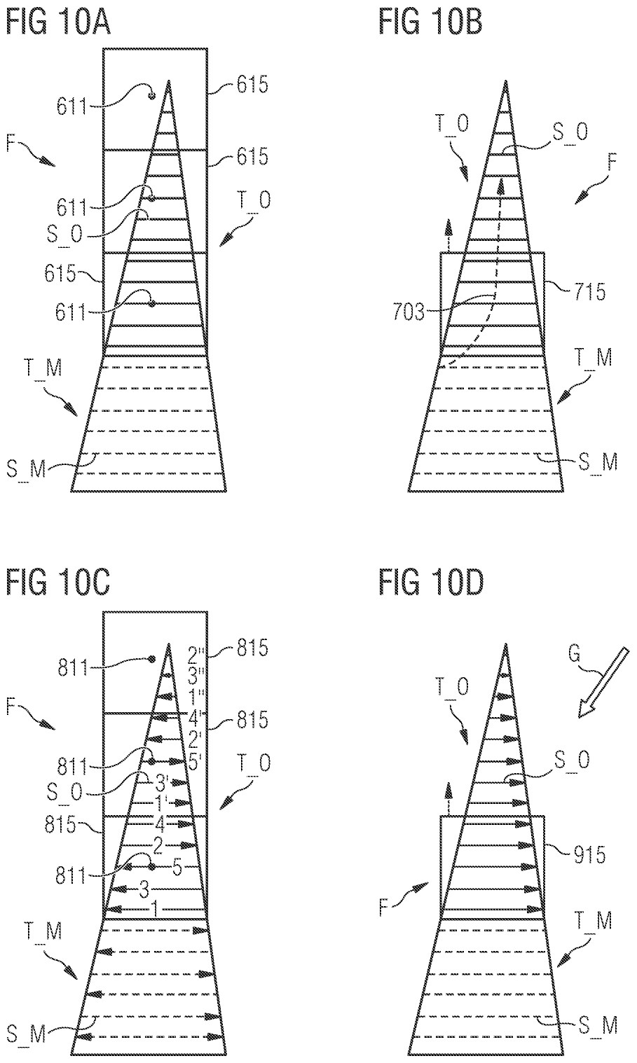

Finally, the concepts disclosed herein can be used during additive manufacturing of a delicate structure of a component part, for example of the order of the size of the beam region provided by the optical deflection. In this case, the mechanical deflection, optionally complemented with the optical deflection, can be used for coarser, larger structures, especially extensive structures. In some embodiments, delicate structures, in particular contained structure sections, can be produced purely by controlling the deflection device and producing a local beam profile—formed by means of a virtually simultaneous illumination of a plurality of beam positions in the beam region of the optical deflection—at a fixed irradiation position without the scanner device being controlled, in particular by virtue of a beam profile in the form of the structure section to be formed being produced by suitably controlling the deflection device. Scanning delicate structures by way of an energy beam is explained in the context of FIGS. 10A to 10D.

For the implementation of the concepts mentioned above and explained below in exemplary fashion in the context of the figures, an optical deflector can be installed in the beam path of the energy beam in addition to a conventional scanner device. A beam deflection by way of the optical deflector can be integrated in the machine controller of the manufacturing device as a further parameter for additive manufacturing. Using such a combination of a mechanical deflection (e.g., galvanometer scanner) for a positioning/shift/displacement of the energy beam over long paths and an optical deflection (e.g., acousto-optic deflector) for very fast positioning without loss of time within a locally restricted region (beam region of the optical deflection), it is possible to realize a flexible control of the spatial and temporal energy input between a plurality of interaction zones without loss of time. Especially for a continuous energy beam/cw laser beam, the switching of beam positions by way of an optical deflection device (AOD/EOD) allows a higher energy of the energy beam/power of the cw laser beam to be introduced into the powder material.

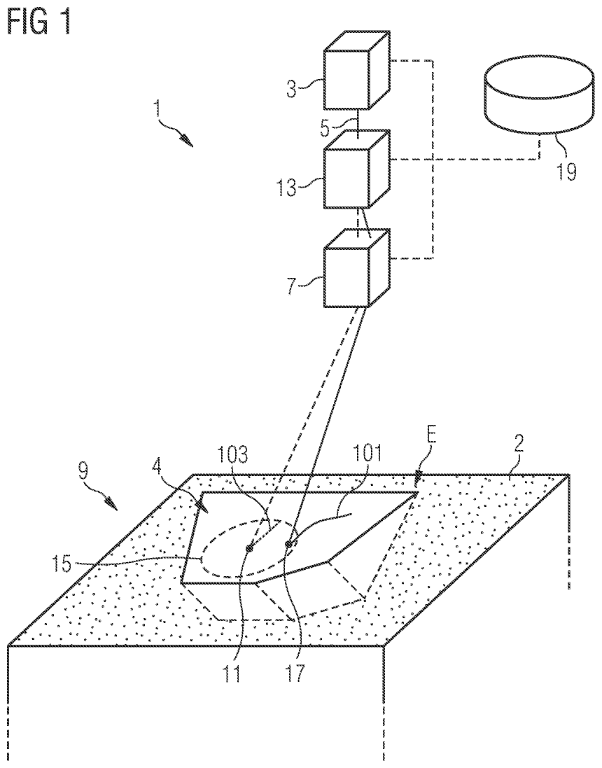

FIG. 1 shows a manufacturing device 1 for additive manufacturing of component parts from a powder material 2. The manufacturing device 1 comprises
a beam producing device 3 configured to produce an energy beam 5,
a scanner device 7 configured to displace the energy beam 5 to a plurality of irradiation positions 11 (mechanical deflection) within a work region 9, which is usually given by the dimensions of a powder bed of the manufacturing device, in order to produce a component part 4 by means of the energy beam 5 from the powder material 2 arranged within the work region 9,
a deflection device 13 configured to displace—in particular abruptly displace—the energy beam 5 to a plurality of beam positions 17 within the beam region 15 (optical deflection) proceeding from an irradiation position 11 of the plurality of irradiation positions 11 within a beam region 15, and
a control device 19 operatively connected to the deflection device 13, and optionally to the beam producing device 3 and the scanner device 7, and configured to control the deflection device 13 in order to assume (with the energy beam 5) the beam positions of the beam region 15 which are required for the production of the component part 4.

The manufacturing device 1 is preferably configured for selective laser sintering and/or for selective laser melting within the scope of additive manufacturing of component parts. The already partially manufactured component part 4 is indicated in FIG. 1, with already solidified layers being covered by the powder material 2 in the powder bed.

The manufacturing device 1 provides a work area comprising the work region 9 and optionally a powder storage region, usually in a sealed housing (not shown). For a (layer-by-layer) construction of the component part 4 by means of the energy beam 5, the powder material 2 is applied sequentially/layer-by-layer within the work region 9. To locally solidify the powder material 2, the powder material 2 is locally impinged by the energy beam 5 within the work region 9 in order to produce the component part 4 layer-by-layer. In particular, a layer of the component part 4 is formed by virtue of the (continuous) energy beam 5 being displaced along an irradiation path 101 formed by a sequence of beam positions 17. The irradiation path 101 is designed such that, within the work region 9 of the manufacturing device 1, the powder material 2 of a powder layer is solidified in accordance with the geometry of the component part 4.

The location of a beam position 17 where the energy beam 5 strikes the work region 9 arises from the undertaken adjustments of the mechanical deflection and optical deflection. An irradiation position 11, from which the optical deflection can be considered, can be assigned to the mechanical deflection. Usually, the irradiation positions 11 (substantially) span the work region 9. Proceeding from a given irradiation position 11, the resultant possible beam positions 17 span the beam region 15. That is to say, the energy beam 5 can be displaced within a corresponding beam region 15 about each of the irradiation positions 11, wherein irradiation positions 11 usually can be set within the entire work region 9 as starting points for corresponding beam regions 15. The beam region 15 has a two-dimensional extent that is greater than a cross section of the energy beam 5 projected onto the work region 9. The beam region 15 is very much smaller than the work region 9. In particular, the beam region 15 preferably has a length scale of the order of a few millimeters (i.e., less than ten millimeters) to a few centimeters, and preferably a two-dimensional extent of the order of a few square millimeters to a few square centimeters. By contrast the work region 9 may have a length scale of the order of a few decimeters to a few meters, and preferably have a two-dimensional extent of the order of a few square decimeters to a few square meters.

Expressed differently, an irradiation position 11 is understood to mean, in particular, a location within the work region 9 at which energy can be deposited locally into the work region 9, in particular into the powder material 2 arranged there, by means of the energy beam 5. The energy input determines the respective interaction zone and hence a melt region of the powder material 2. The scanner device 7 is configured—assuming there is no superposition of an optical deflection—to displace the energy beam 5 along a “mechanical” scanning path 103 within the work region 9, the mechanical scanning path 103 consisting of a temporal sequence of irradiation positions 11 successively swept over by the energy beam 5. In this case, the individual irradiation positions 11 may be arranged spaced apart from one another, or may otherwise overlap with one another and merge into one another.

If an optical deflection is overlaid on the mechanical deflection, this yields the irradiation path 101 formed by the sequence of beam positions 17 set by the scanner device 7 and the optical deflection device 13. The resultant irradiation path 101 may be a path that is continuously scanned by the energy beam 5. Further, the resultant irradiation path 101 may have path segments that each comprise at least one beam position 17. Scanning the path segments with the energy beam 5 may comprise jumps between spatially spaced apart path segments, with the jumps being controlled by the optical deflection device 13.

The beam producing device 3—for example in the form of a continuous wave (cw) laser—supplies the energy beam 5 for fusing the powder. In general, an energy beam is understood to mean directed radiation that is able to transport energy. In general, this may be particle radiation or wave radiation. In particular, the energy beam propagates through physical space along a propagation direction and transports energy along its propagation direction in the process. In particular, local deposition of energy into the powder material 2 within the work region 9 is possible by means of the energy beam.

Herein, the energy beam 5 is generally an optical work beam that is consequently deflectable by means of the optical deflection device 13. In particular, an optical work beam is understood to mean directed, either continuous or pulsed, electromagnetic radiation which, in terms of its wavelength or a wavelength range, is suitable for additive manufacturing of the component part 4 from the powder material 2, more particularly for sintering or melting the powder material 2. In particular, an optical work beam is understood to mean a laser beam which—preferably continuously—is radiated onto the work region 9. The optical work beam preferably has a wavelength or a wavelength range within the visible electromagnetic spectrum or within the infrared electromagnetic spectrum or within the overlap range between the infrared range and the visible range of the electromagnetic spectrum.

In summary, a beam guiding system of the manufacturing device 1 for guiding the energy beam 5 to the powder bed consequently comprises the scanner device 7 for a mechanically induced deflection of the energy beam 5. In the scanner device 7, a deflection of the energy beam 5 (e.g., the laser beam in this case) can be brought about for example by way of a rotation of mirrors (for example, by means of a galvanometer scanner). The mechanical deflection can be used to scan an irradiation path 101 for exposing a powder layer, either on its own (scanning path 103) or in combination with an optical deflection.

The scanner device 7 preferably comprises at least one scanner, in particular a galvanometer scanner, a piezo-scanner, a polygon scanner, a MEMS scanner and/or a work head or processing head that is displaceable relative to the work region. Such scanner devices are known and especially suitable for displacing the energy beam 5 between a plurality of irradiation positions 11 within the work region 9.

On account of the inertia of an optical element to be moved mechanically (e.g., a deflection mirror), a spatial distribution of the energy input controlled only by means of mechanical deflection is sluggish. As a result, irradiation paths intended to be scanned purely by mechanical deflection, for example the scanning path 103, may expose the additive manufacturing process to the risk of local overheating of the powder melt. Attention is drawn to the fact that local overheating in the case of a purely mechanical deflection is avoidable by non-productive times (delays introduced into the irradiation process) but accompanied by a loss of productivity. The concepts proposed herein are able to prevent or at least reduce this loss of productivity.

According to the invention, the beam guiding system of the manufacturing device 1 for guiding the energy beam 5 to the powder bed further comprises the deflection device 13 for an optically induced deflection. The deflection device 13 is configured to displace the energy beam 5 within the beam region 15—if a fixed irradiation position 11 is assumed—and thus to be able to impinge a certain region—the beam region 15—within the work region 9 with the energy beam at the fixed irradiation position 11. The beam region 15 is larger than the cross section of the energy beam 5 projected onto the work region 9.

Since the scanner device 7 is configured to displace the energy beam between irradiation positions 11, it allows the deflection device 13 to sweep over a new beam region 15 around a different irradiation position, that is to say at a different location within the work region 9, with the energy beam 5. The deflection device 13 therefore serves a local deflection of the energy beam 5 proceeding from an irradiation position 11 while the scanner device 7 serves the global displacement of the energy beam 5 within the work region 9.

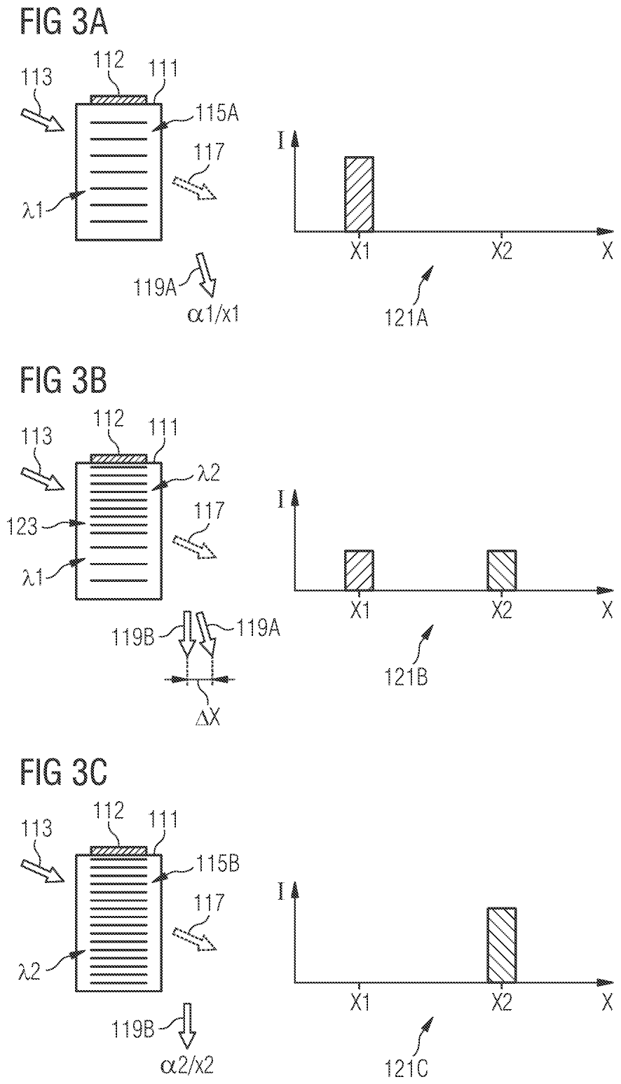

In particular, the deflection device 13 is configured to abruptly displace the energy beam 5 to the plurality of beam positions 17 within the beam region 15, wherein the beam positions 17 may be discrete beam positions. In particular, it is possible that successively processed beam positions 17 are arranged spaced apart from one another. However, it is also possible that successively processed beam positions 17 overlap one another at least regionally and merge into one another. In some embodiments, the energy beam 5 is not displaced continuously from beam position to beam position by the deflection device 13, but is displaced in discrete steps instead. Without loss of generality and without wanting to be tied to theory, the assumption can be made for all practical application purposes that the energy beam 5 virtually disappears at a first beam position and arises at a second beam position without in particular sweeping over intermediate regions in the case of an abrupt or discrete displacement from the first beam position to the second beam position. In this respect, see the explanations in relation to FIGS. 3A to 3D. In this way, a very fast displacement of the energy beam 5 is possible within the beam region 15, and it is preferably possible to avoid material transport processes that may occur in the case of a continuous displacement of the energy beam 5, especially in the case of a high energy input, as a result of which it is possible to increase the quality of the component part arising.

Examples and explanations regarding optical deflectors for an optically induced deflection of a laser beam are disclosed inter alia in “Electro-optic and acousto-optic laser beam scanners”; Römer G. R. B. E. et al., Physics Procedia 56 (2014) 29-39.

Optical deflectors comprise acousto-optic deflectors (AOD), which are based on the generation of a periodic change in the refractive index during the propagation of acoustic waves in an optically transparent material of the AOD (usually an optically transparent crystal). An optical deflection using a schematically depicted AOD 111 and a change in the acoustic excitation are elucidated in FIGS. 3A to 3C. With regard to the diffraction behavior present at the AOD, supplementary reference is made to FIG. 3 in Römer et al. Thus, a diffraction angle of the first order of diffraction arises depending on the laser wavelength, the refractive index of the undisturbed material, the frequency of the acoustic wave and the speed of the acoustic wave in the material. An angular range scannable by the first order arises from the bandwidth with which acoustic waves can be excited within the material.

FIG. 3A schematically shows how an incident laser beam 113—preferably at an angle of incidence of the order of the Brewster angle—is incident on the AOD 111, in particular on a passage region of the AOD 111. On account of an acoustic excitation on the upper side of the AOD 111 (e.g., by way of an exciter 112 for producing acoustic waves in the material), a grating-like structure 115A (refractive index modulation, acousto-optic diffraction grating) forms in the AOD 111. This is characterized by an excitation wavelength 1. The incident laser beam 113 is diffracted at the grating-like structure 115A such that, in addition to a zeroth order non-diffracted beam 117 (with as little intensity as possible), a first order diffracted laser beam 119A (with the greatest possible intensity) leaves the AOD, in particular the passage region of the AOD 111, at a deflection angle α1 assigned to the wavelength 1.

In the arrangement of FIG. 1, the first order laser beam 119A would be fed to the scanner device 7 and would strike the powder bed from above at a location x1, with the deflection in the AOD (i.e., the set first order deflection angle α1) also determining the final position on the powder bed. Accordingly, the energy input occurs at the location x1, as shown by a schematic intensity distribution I(x) 121A.

If the wavelength of the exciting acoustic wave is varied continuously or discretely, there is a change in the angle of the first order of diffraction, and hence in the position of the laser beam 119A. Varying the wavelength of the excited acoustic wave enables a controllable deflection of the diffracted beam; i.e., a sought-after target position of the energy input can be adjusted on the powder bed.

Expressed differently, changing the acoustic wavelength leads to a replacement of the first acoustic wave with a second acoustic wave in the AOD. Sound speeds in solid bodies are of the order of, e.g., 1000 m/s or a few 1000 m/s (dependent inter alia on the hardness of the crystal). Should a first acoustic wave (with a first wavelength) in for example a crystal of the AOD be completely replaced by a second acoustic wave (with a second wavelength), the first acoustic wave must first completely propagate out of the crystal so that it can be replaced (as simultaneously as possible) by the second acoustic wave. Assuming an energy beam with a diameter of approximately 1 cm acts on the crystal, the acoustic wave passes through this distance in a few microseconds, for example approximately 3 μs. After this time there is the interaction with the second acoustic wave. In general, this time becomes longer the larger and softer the crystal is and shorter the smaller and harder the material of the AOD is. During the change from the first acoustic wave to the second acoustic wave, energy (the laser beam) can temporarily be diffracted into the corresponding first orders at both arising grating-like structures. In general, a switchover between acoustic waves, and hence a deflection of the energy beam to different locations (i.e., a switchover of the deflection from a first to a second angle) can be implemented in the megahertz timescale range.

FIGS. 3B and 3C elucidate an abrupt position change with the aid of the AOD 111. To this end, the exciting acoustic wave is changed to a wavelength λ2 (grating-like structure 115B, deflection angle α2 of the first order laser beam 119B, location x2 of the energy input on the powder bed). The change in the exciting acoustic wave accordingly brings about a change in position of the diffracted laser beam 119B by a discrete distance Δx (“x2−x1”).

In FIG. 3B, a transition 123 between the refractive index modulations in the AOD is evident, wherein the transition 123 has already migrated to the center of the AOD 111 proceeding from the upper side. At this time, one half of the incident laser beam 113 is incident on the refractive index modulation with wavelength λ1 and the other half is incident on the refractive index modulation with wavelength λ2. Accordingly, a schematic intensity distribution I(x) 121B exhibits the same intensities/energy inputs for the diffracted laser beams 119A and 119B at the respective locations x1 and x2.

If, as shown in FIG. 3C, the refractive index modulation with wavelength λ2 has formed over the entire AOD 111, the maximum intensity of the laser beam 119B will strike the powder bed at the location x2 (see intensity distribution I(x) 121C).

The advantage of the beam displacement using an AOD is evident from the intensity distribution I(x) 121A to 121C; in the example, the beam displacement realizes the aforementioned case where a region between start position (location x1 in this case) and end position (location x2 in this case) is not exposed to the laser beam since the periodic changes in the refractive index temporally merge into one another substantially without the formation of the diffractive transition behavior. Accordingly, the energy input is restricted to the start position and the end position; this corresponds to an abrupt change in the optical deflection.

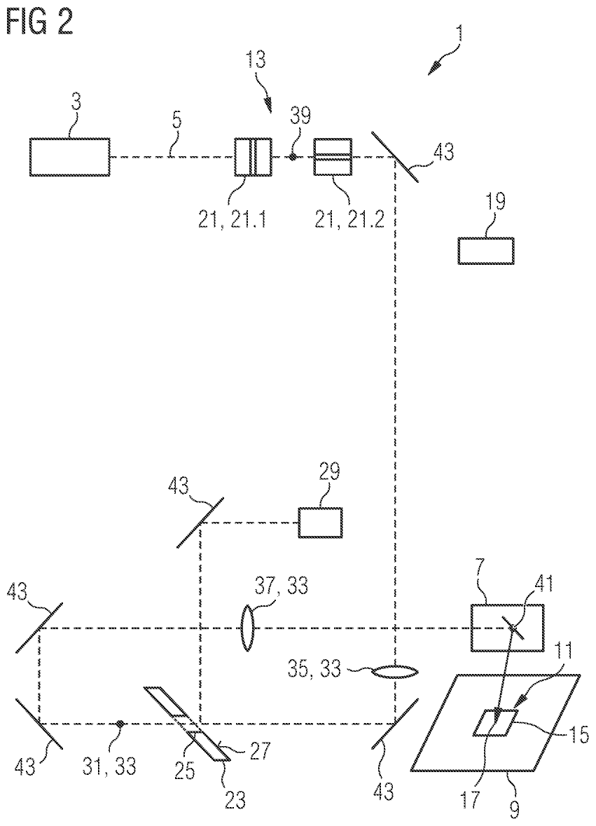

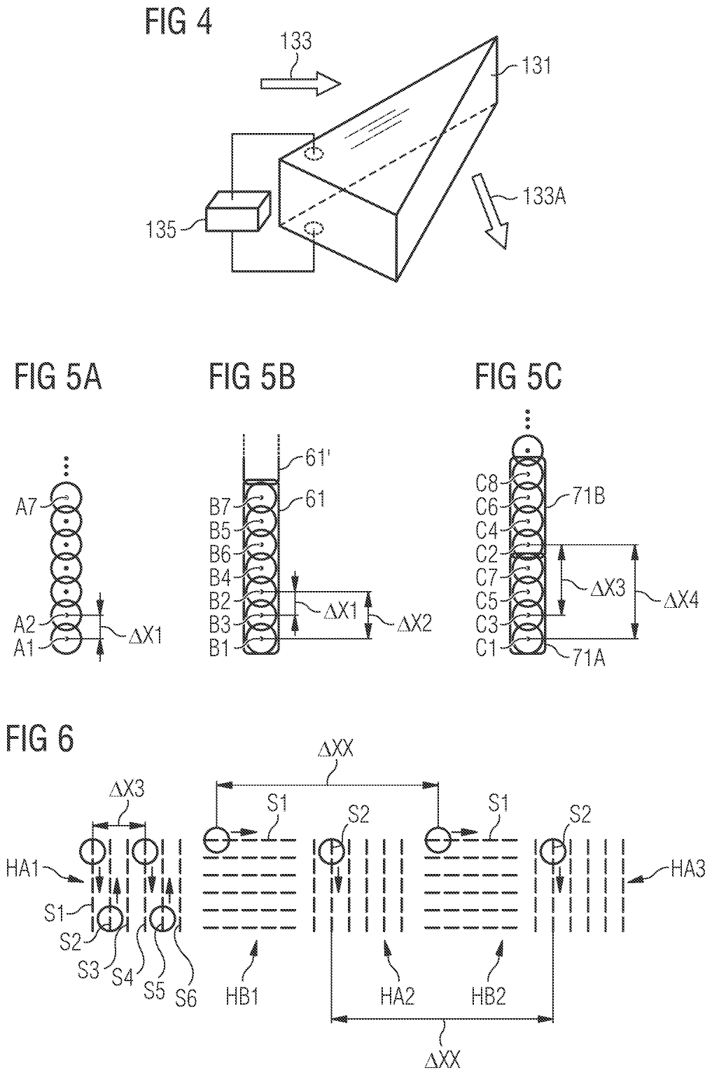

Optical deflectors further comprise electro-optic deflectors (EOD), the deflection of which is based upon refraction during the passage through an optically transparent material. FIG. 4 schematically shows an adjustable optical deflection using an EOD 131, with the optically transparent material of the EOD 131 being adjustable in terms of refractive index or in terms of a refractive index gradient by way of the application of a voltage. The deflection of a laser beam 133 varies on the basis of the applied voltage, said laser beam preferably again being incident on the EOD 131 at the Brewster angle and emerging from the said EOD at a correspondingly adjustable deflection angle. A laser beam 133A deflected thus could be fed to the scanner device 7 in the arrangement of FIG. 1. A voltage source 135 enables a precise adjustment of the voltage, which is applied, for example, between the upper and lower side of the prism-shaped crystal forming the EOD 131 in FIG. 4. The refractive index or refractive index gradient, and hence the optical deflection, can be set on the basis of the set voltage. With regard to the refraction behavior present at the EOD, supplementary reference is made to FIG. 2 in Römer et al.

Both AODs and EODs can bring about the deflection of a laser beam referred to as optical deflection herein, which can be adjusted quickly, that is to say virtually in real time in relation to the powder fusing process in additive manufacturing.

Referring to FIG. 1 again, the scanner device 7 and the optical deflection device 13 differ not only in terms of the extent of the implementable deflection but also in terms of the timescale on which a deflection of the energy beam 5 is implemented: In particular, the deflection of the energy beam 5 within the beam region 15 by way of the optical deflection device is implemented preferably on a shorter timescale, in particular a very much shorter timescale, than the deflection within the work region 9 by way of the scanner device 7, that is to say the said deflection is implemented very much quicker than the change from one irradiation position to the next irradiation position. Preferably, the timescale on which the energy beam can be deflected by the deflection device (e.g., jumping over a maximum extent of the beam region, that is to say from, e.g., “−5 mm” to “+5 mm”, within a microsecond corresponding to a speed of 10 000 m/s; in general, there is a virtually instantaneous jump from any desired point within the beam region to any other point within the beam region) is smaller by a factor of 10 to 10 000, preferably from 20 to 200, preferably from 40 to 100, or more, than the timescale on which there is a deflection of the energy beam by the scanner device.

The control device 19 is configured to implement the movement of the point of incidence of the energy beam 5 on the powder bed in accordance with a specified irradiation strategy. The control device 19 is preferably selected from a group consisting of a computer, more particularly a personal computer (PC), a plug-in card or control card, and an FPGA board. In a preferred configuration, the control device 19 is an RTC6 control card by SCANLAB GmbH, in particular in the current configuration obtainable at the priority date of the present property right.

The control device 19 is preferably configured to synchronize the scanner device 7 with the deflection device 13 by means of a digital RF synthesizer. In this case, the RF synthesizer can be controlled by way of a programmable FPGA board of the control device 19. Additionally, there preferably is a division into the comparatively slow movement of the scanner device 7 and the fast movement of the deflection device 13 by means of a frequency divider. Preferably, position values and default values for the movement of the point of incidence are calculated, and these can then be converted in the FPGA board into temporally synchronous frequency specifications for the RF synthesizer. To this end, it is possible to implement a spatial assignment of the optical deflection to irradiation positions 11 in the respective powder material layer. The latter can preferably already be carried out in a build processor when creating the irradiation strategy. The build processor can write the corresponding data into a control file, for example, which can preferably be read and implemented by the control device 19.

In particular, the scanner device 7/the mechanical deflection on the one hand and the deflection device 13/the optical deflection on the other hand allow a separation of the time and length scales relevant to the production of the arising component part 4. While the scanner device 7 is configured to displace the energy beam virtually globally along the plurality of irradiation positions 11, in particular along a predetermined scanning path 103, over the entire work region 9 at a longer timescale in comparison with the deflection device 13, the deflection device 13 is configured to displace the energy beam virtually locally to the plurality of beam positions 17 within the beam region 15 at an irradiation position 11, which is virtually stationary on account of the timescale separation and which is specified by the scanner device 7, at a shorter timescale relative to the timescale of the scanner device 7.

On account of the timescale separation, in some embodiments there can be, quasi-statically, a local scanning sequence of beam positions 17 in the respective beam region 15 at each irradiation position 11 of the plurality of irradiation positions 11 and/or a certain beam profile may arise as geometric form and as intensity profile of the beam region 15. Expressed differently, the scanner device 7 is able to displace the beam profile generated thus and, in general, the beam region 15, that is to say the beam positions 17 that can be homed in on optically, along the plurality of irradiation positions 11, in particular along the scanning path 103. By changing the control of the deflection device, it is now advantageously possible to change the beam profile of the beam region, that is to say in particular the shape of the beam region and/or the intensity profile in the beam region, virtually as desired, where necessary even from irradiation position to irradiation position. Further, a scanning sequence during the displacement of the beam positions 17 is able to take account of thermal effects. In some embodiments, a plurality of adjacent irradiation positions 11, in particular a respective contiguous section of the scanning path 103, can be swept over with the same beam profile and/or the same scanning sequence. Alternatively, different sections of the scanning path 103 can be swept over with different beam profiles and/or different scanning sequences.

The produced beam profile and/or the scanning sequence can be considered quasi-static in view of the melting process in the powder material 2 in some embodiments, with the timescale for the deflection of the energy beam 5 by the optical deflection device 13 being significantly shorter than the characteristic interaction time between energy beam 5 and powder material 2. Then, averaged over time, the dynamically generated beam profile can interact with the powder material like a statically produced profile. The same applies to the scanning of the dynamically generated scanning sequence.

FIG. 2 illustrates an exemplary beam path, as can be implemented in the manufacturing device 1 of FIG. 1. In the propagation direction of the energy beam 5, the deflection device 13 is upstream of the scanner device 7. In particular, the deflection device 13 has at least one acousto-optic deflector 21, in this case two non-parallel acousto-optic deflectors 21 oriented perpendicular to one another in particular, specifically a first acousto-optic deflector 21.1 and a second acousto-optic deflector 21.2. The acousto-optic deflectors 21 oriented perpendicular to one another allow a deflection of the energy beam 5 in two mutually perpendicular directions and hence, in particular, allow two-dimensional scanning of the beam region 15. The non-parallel acousto-optic deflectors 21.1 and 21.2 are preferably arranged in succession in the propagation direction of the energy beam 5.

In particular, an acousto-optic deflector is understood to mean an element with a solid body which is transparent to the energy beam and to which acoustic waves, in particular ultrasonic waves, can be applied, with the energy beam being deflected upon the passage through the transparent solid body, in a manner dependent on the frequency of the acoustic waves applied to the transparent solid body. In the process, an optical grating, in particular, is generated by the acoustic waves within the transparent solid body. Advantageously, such acousto-optic deflectors are able to very quickly deflect the energy beam within an angular range specified by the frequency of the acoustic waves produced within the transparent solid body. In particular, switching speeds of up to 1 MHz can be attained in the process. In particular, the switching times for such an acousto-optic deflector are significantly faster than typical switching times for conventional scanner devices, in particular galvanometer scanners, which are generally used to displace an energy beam within a work region of a manufacturing device of the type under discussion here. Therefore, such an acousto-optic deflector can particularly suitably be used to produce a quasi-static beam profile within the beam region.

Modern acousto-optic deflectors are able to deflect the energy beam into a predetermined angular range of the first order of diffraction with an efficiency of at least 90% (in particular at least 80%), and so they are eminently suitable as a deflection device for the manufacturing device proposed here. Decisive for the high efficiency are, in particular, the employed material that is transparent to the energy beam and a suitably high intensity of the input coupled ultrasonic waves.

Especially if the deflection device 13 has acousto-optic deflectors, the AODs produce, on account of their configuration analogous to an optical grating, a non-diffracted partial beam of zeroth order and a diffracted or deflected partial beam of first order. However, usually it is only the first order partial beam that should be used to irradiate the work region. In the embodiment shown in FIG. 2, the manufacturing device 1 moreover comprises a separation mirror 23 which is arranged downstream of the deflection device 13 and upstream of the scanner device 7 in the propagation direction of the energy beam 5 and configured to separate the zeroth order partial beam from the first order partial beam of the energy beam 5. To this end, the separation mirror 23 comprises a passage bore 25 in particular, which is provided in a surface 27 of the separation mirror 23 that is reflective for the energy beam 5 and which completely passes through the separation mirror 23. The first order partial beam that is intended to be transmitted to the scanner device 7 is guided through the passage bore 25 in this case and thus finally arrives at the scanner device 7. The unwanted zeroth order partial beam and optionally also unwanted higher order partial beams, by contrast, strike the reflective surface 27 and are deflected to a beam trap 29.

In particular, the separation mirror 23 is arranged in the surroundings of an intermediate focus 31 of a telescope 33, especially not precisely in a plane of the intermediate focus 31, particularly preferably offset along the propagation direction at a distance of one fifth of the focal length of the telescope 33, in particular upstream of the intermediate focus 31. Advantageously, this avoids an impingement of the reflective surface 27 with an energy beam 5 whose power density is too high.

The telescope 33 preferably comprises a first lens 35 and a second lens 37. It is preferably designed as a 1:1 telescope. Preferably, the telescope 33 has a focal length of 500 mm.

The functionality of the telescope 33 is preferably twofold: Firstly, the telescope 33 enables a particularly advantageous and clean separation of the various orders of the energy beam 5 deflected by the deflection device 13, especially in the case of the arrangement of the separation mirror 23 chosen here; secondly, the telescope 33 preferably images an imaginary, common beam point of rotation 39 of the deflection device 13 advantageously onto a pivot point 41 of the scanner device 7. Alternatively, the telescope 33 preferably images the beam point of rotation 39 onto a point of smallest aperture.

To facilitate a compact arrangement of the manufacturing device 1, the energy beam 5 is preferably deflected multiple times by deflection mirrors 43.

In summary, within the scope of a method for displacing a continuous energy beam along an irradiation path formed by a sequence of beam positions during the additive manufacture of a component part 4 from a powder material, the energy beam 5 can be displaced preferably within the work region 9 to a plurality of beam positions 17 in order to produce the component part 4 layer-by-layer from the powder material 2 arranged in the work region 9 by means of the energy beam 5. With respect to an irradiation position 11, the energy beam 5 is displaced to a plurality of beam positions 17 within a beam region 15.

In preferred embodiments, a continuous energy beam is continuously displaced, at least sectionally, along an irradiation path. By way of example, a cw laser beam can be displaced continuously along scanning vectors of an irradiation path that are defined within the scope of the irradiation strategy, wherein the scanning vectors respectively run parallel to one another in irradiation zones (hatches). The scanning vectors of an irradiation zone can be traversed uniformly in the same direction or alternately in opposite directions. This corresponds to a continuous exposure of the scanning vectors.

FIG. 5A shows as an example for a continuous displacement a linear scanning procedure, within the scope of which spaced apart beam positions A1, A2, . . . , A7 are abruptly homed in on in succession by virtue of the optical deflection bringing about a change in position of the energy beam 5 by a discrete distance ΔX1. Schematically, circles are additionally indicated about beam positions A1, A2, . . . , A7 in FIG. 5A, said circles elucidating an extensive region in which the energy input by way of the energy beam incident on a beam position leads to the powder material melting. In general, adjacent beam positions of a subsequence can be arranged spaced apart from one another by at least one diameter of the energy beam or by at least 50% of the diameter of the energy beam within the work region.

It is evident from FIG. 5A that the distance ΔX1 was chosen in such a way that adjacent melting regions partially overlap such that continuous melting of the powder material can be brought about. In the present example of FIG. 5A, melting is implemented along a line, for example along a scanning vector in an irradiation zone.

The linear scanning procedure can be carried out either from a fixed irradiation position or in the case of a changing mechanical deflection, wherein, in the latter case, the optical deflection (the distance ΔX1) should be adapted in the irradiation strategy in accordance with the mechanically induced movement of the irradiation position.

Further, discontinuous displacement of the energy beam can be carried out, with positions along the irradiation path being abruptly homed in on and illuminated. Such a discontinuous exposure can be carried out, for example, within a scanning vector of an irradiation zone, when changing to non-adjacent scanning vectors within an irradiation zone, or when changing between irradiation zones.

In these cases, a cw laser beam can scan for example discrete beam positions along the irradiation path in a sequence fixed in the irradiation strategy. A discontinuous exposure differentiates between a geometry of the irradiation path and an adjustability of a time of irradiation. Consequently, the geometry of the irradiation path is assigned a sequence of times at which the respective beam positions of the irradiation path are exposed. The geometry of the irradiation path is substantially given by the layer-specific cross section of the component part 4, with segments of the irradiation path possibly being introduced for technical reasons; these are, for example, the (in particular parallel linear) scanning vectors running next to one another in the irradiation zones, with adjacent irradiation zones possibly having different orientations of the scanning vectors. The adjustability of the time of irradiation determines parameters of the interaction of the energy beam with the powder material at a beam position. By way of example, a duration of the irradiation is specified by adjusting time intervals between the change between beam positions. Further, the choice of the distance between beam positions may influence thermal aspects, for instance a dissipation of introduced heat into the powder material/the powder melt.

FIG. 5B shows a first example of a discontinuous displacement of the energy beam within the scope of a linear scanning procedure. A scanning sequence in FIG. 5B comprises a group 61 of, for example, seven beam positions B1, B2, B3, B4, B5, B6, B7 which are abruptly scanned in accordance with a given sequence. To this end, the optical deflection brings about position changes of the energy beam 5, which position changes consist of a plurality of possible discrete distances, two distances ΔX1 and ΔX2 being depicted in exemplary fashion in FIG. 5B. In this case, the discrete distances are chosen in such a way that the discrete distance ΔX2 skips a beam position. The scanning sequence can be carried out from a fixed irradiation position (i.e., the mechanical deflection is temporarily halted to be stationary or can be considered to be stationary). Further, scanning sequences can adjoin one another in space (as indicated by a group 61′ in FIG. 5B, for example proceeding from a correspondingly advanced irradiation position) and/or they can be repeated at the same location and/or with a spatial offset. Further, a continuous mechanical deflection can be overlaid on the optical deflection, with the optical deflections (the distances ΔX1 and ΔX2) having to be adapted in the irradiation strategy in accordance with the movement of the irradiation position.

Circles elucidating melt regions are once again indicated schematically around the beam positions 317A, 317B, 317G in FIG. 5B. On account of the scanning sequence 61, it is not only adjacent beam positions that are exposed successively, and so there are new thermal interaction parameters, which differ from those of the irradiation strategy elucidated in FIG. 5A. As a result, there is once again melting along a line, for example along a section of a scanning vector in an irradiation zone. However, in some embodiments, the new thermal interaction parameters may allow the energy input with the energy beam to be increased, with the irradiation duration at a beam position being shortened at the same time. Accordingly, the manufacturing process can be carried out more efficiently in time.

FIG. 5C shows a further example of a discontinuous displacement of the energy beam. In this case, an underlying scanning sequence is chosen such that adjacent groups 71A, 71B of four beam positions C1, C3, C5, C7 and C2, C4, C6, C8, respectively, are irradiated virtually simultaneously. To this end, the optical deflection brings about position changes of the energy beam 5, within the scope of which two or three beam positions are skipped; two possible discrete distances ΔX3 and ΔX4 are indicated in exemplary fashion in FIG. 5C.

The beam positions B1, . . . , B7 and C1, . . . , C8 each represent subsequences of beam positions (17), which comprise only one beam position of the sequence of the irradiation path (101). A person skilled in the art will acknowledge that these subsequences can be extended to two or more adjacent beam positions for as long as the energy influx remains within the specified limits. The irradiation strategies in FIGS. 5B and 5C consequently represent examples of subsequences which are scanned in such a way that the energy beam skips a region between the spaced apart subsequences by way of an abrupt change in the optical deflection such that spatially spaced apart, in particular thermally decoupled subsequences are successively adopted by the energy beam (one distance from a beam position is present in exemplary fashion in the examples of FIGS. 5B and 5C).

In general, beam positions of a subsequence can be arranged spaced apart from one another by at least 1.5- to 2-times the diameter of the energy beam, or more, within the work region. In general, when alternating between subsequences, regions of the work region which are selected from the group of regions comprising a not yet irradiated region of the work region, a region of the work region not to be irradiated, and an already irradiated region of the work region further can be skipped. A person skilled in the art will acknowledge that at least one beam position which was skipped during the scanning of the sequence of beam positions can be scanned at a subsequent time.

In this case, too, a fixed irradiation position or a movement of the irradiation position can be assumed. On account of the large distances between successive interaction regions, the energy input can be further increased and the irradiation duration can be accordingly shortened, and so the manufacturing process can be carried out efficiently.

In a further irradiation strategy, it is possible to skip forward along the irradiation path by a maximum jump distance (e.g., from beam position A1 in FIG. 5A to beam position A7) in order then to jump backward with smaller jumps counter to the movement direction of the mechanical deflection until all skipped beam positions along the irradiation path have been adopted (for example, in the sequence A2-A3-A4-A5-A6 in FIG. 5A as an example of a subsequence of beam positions comprising a plurality of beam positions). Then, there is a maximum jump forward along the irradiation path, etc.

FIG. 6 shows how two or more scanning vectors can be exposed simultaneously within one irradiation zone or in a plurality of irradiation zones by using the optical deflection. It is possible to identify a lining-up of irradiation zones HA1, HB1, HA2, HB2, HA3, wherein parallel scanning vectors S1 to S6 in each of the irradiation zones should be exposed in accordance with the irradiation strategy, with the scanner device 7 carrying out the deflection of the energy beam in the direction of the scanning vectors S1 to S6 in the respective irradiation zone. A continuously irradiated scanning vector of an irradiation zone represents a subsequence of beam positions which comprises a plurality of beam positions. By way of example, an irradiation zone (hatch) may have an edge length ranging from a few millimeters to a few centimeters. These dimensions are of the order of the jump distance that can be implemented by means of an optical deflection device (AOD/EOD), for example of the order of a few millimeters, for example ±10 mm, usually at least ±5 mm.

To elucidate that the scanning vectors S1 to S6 are primarily traversed by way of the scanner device 7, the scanning vectors were depicted using dashed lines. Different alignments of the scanning vectors S1 to S6 are present in adjacent irradiation zones, and so the scanning vectors S1 to S6 respectively run in parallel in the irradiation zones HA1, HA2, HA3, just as in the irradiation zones HB1, HB2. A corresponding arrangement in two dimensions yields what is known as a checkerboard arrangement of irradiation zones, with the concepts being analogously applicable to strip arrangements of irradiation zones.

An implementation of jumps within the irradiation zone HA1 is indicated in the irradiation zone HA1. During the mechanical deflection in the direction of the scanning vectors, the optical deflection device brings about jumping between the scanning vectors. In the example of FIG. 6, the energy beam for example jumps between the scanning vectors S1-S4 or S2-S5 or S3-S6; in this case, there are always two scanning widths (of the size of the melt regions) between the locations of the energy input (distance ΔX3 to be jumped).

Scanning vectors in different irradiation zones can be exposed simultaneously if different irradiation zones are within the range of the optical deflection. In FIG. 6, the optically induced jumps can be implemented, e.g., in the direction of the mechanical deflection (indicated simultaneous exposure of scanning vectors S1 in irradiation zones HB1 and HB2, distance ΔXX) or transversely to the mechanical deflection (indicated simultaneous exposure of scanning vectors S2 in irradiation zones HA2 and HA3, distance ΔXX).

Alternatively, the scanner device 7 could be positioned in the irradiation zone HA1 at a fixed irradiation position 11 in the center of the irradiation zone HA1. Subsequently, the scanning vectors S1 to S6 can be traversed as described above, with the deflection device 13 bringing about not only a jump between the respective two scanning vectors but also a traversing of the scanning vectors. In a further alternative, the scanner device 7 could be deflected from left to right while the deflection device 13, like in the previous example, brings about jumping between the scanning vectors and the traversal of the scanning vectors. This alternative is particularly suitable for strip arrangements of irradiation zones, in which so many scanning vectors are arranged parallel to one another that these go beyond the beam region 15 of the optical deflection device 13. Such an irradiation strategy can advantageously also find use in the case of delicate structures, as are shown in FIGS. 10A to 10D.

In general, significantly more energy/laser energy can be introduced into the component part if the distance between the homed in on beam positions is chosen to be so large that these beam positions do not influence one another thermally. As a result, the productivity can be increased in comparison with drawing a melt track in the powder bed using a (circular/Gaussian) laser beam.

As shown on the basis of the scanning sequences of FIGS. 5B and 5C and 6 discussed in exemplary fashion, the energy input in one aspect according to the invention can be controlled on the basis of a temporal and spatial control. This can be used in particular within the scope of additive manufacturing in a protrusion region or in a delicate component part structure. Further, by virtue of the energy input being implemented at discrete spaced apart locations and/or in temporally restricted fashion, this can allow a reduction in or an avoidance of local overheating even in the case of an exposure with continuous laser radiation.

To this end, for example, continuous laser radiation is terminated at this location with the aid of the optical deflection following a powder material type-dependent irradiation duration of the powder material in order to provide the molten material the option for heat dissipation and in order to avoid local overheating with an unwanted expansion of the melt pool. Expressed differently, overheating can be avoided by virtue of the laser beam, following the exposure of a first point (e.g., B1 in FIG. 5B or C1 in FIG. 5C) with the envisaged irradiation duration, skipping to a different second point (e.g., B2 in FIG. 5B or C2 in FIG. 5C) which is far enough away from the first point such that there is no relevant heat input at the first point as a result of exposure at the second point. As a result, local overheating can be realized even in the case of a continuous irradiation (a duty cycle of 1 where possible) and hence without a loss of time.

However, this requires a very fast deflection of the laser beam from the first point to the second point. The fast deflection is required so as to lose as little time as possible as a result of jumping from the first position to the second position and so as to avoid an unwanted exposure/processing of the material along the jumped path. Although the mechanically induced scanner devices (e.g., galvanometer scanners) usually used in apparatuses do not meet this requirement on account of the inertia of the mirrors, a corresponding abrupt displacement can be undertaken by means of an optical deflection as described herein. Since the optical deflection paths realizable by means of AODs, for example, are small, a scanner device such as a galvanometer scanner is additionally required for positioning the laser beam over relatively large regions (in particular the work region 9).

The implementation of an exemplary irradiation path with a significant change of direction is explained in the context of FIG. 7A using the example of a corner E in an irradiation path 201, with the corner E being formed by a linear path segment 201A and a linear path segment 201B of the irradiation path 201 and the linear path segments 201A, 201B meeting one another at right angles.

In general, when exposing an angular contour using only one mechanical scanner device, that is to say a sluggish axis, a scanning movement of an optical component (e.g., a deflection mirror) of the scanner device is temporarily brought to a complete standstill before a further optical component, or the same optical component, is accelerated in a new direction, for example at a 90° angle. In the case of the constant energy input by way of a continuous energy beam (constant laser power), this may lead to the powder melt overheating in the region of the formed corner. Overheating may occur, in particular, if the heat can only be dissipated poorly on account of the non-molten (and accordingly isolating) powder which for example surrounds a pointed structure formed layer by layer.

Using the division, proposed herein, into a mechanical deflection (sluggish axis of the scanner device) and an optical deflection (dynamic axis of the optical deflection device), the sluggish axis can now traverse a rounded curve in the vicinity of the corner (see the exemplary scanning path 203 in the form of a quarter circle in FIG. 7A).

In particular, to this end, a change in the optical deflection of the energy beam can at least partially compensate a change in the mechanical deflection of the energy beam in a direction transversely to the irradiation path 201, and so the irradiation path 201 deviates from a sequence of irradiation positions (scanning path 203) set by means of the scanner device 7. Optionally, the optical deflection of the energy beam (5) may have a component in the direction of the irradiation path 201 such that, in particular, a speed with which the sequence of beam positions 217 is scanned in a segment (path segments 201A, 201B) of the irradiation path 201 is constant or remains within a target speed range about a specified speed.

In general, a change in the optical deflection of the energy beam and a change in the mechanical deflection of the energy beam may at least partially compensate one another in at least one first direction. In at least one second direction, a change in the optical deflection of the energy beam and a change in the mechanical deflection of the energy beam may add.

The dynamic axis carries out a compensation movement in such a way that the energy beam remains on the angular contour, the linear path segments 201A, 201B in FIG. 7A. In this case, a deceleration and a subsequent acceleration in the region of the corner E is limited by the acceleration of the dynamic axis, which is greater than that of the mechanical deflection, and so overheating risks can at least be significantly minimized. When planning the irradiation strategy, care merely has to be taken that position deviations of the irradiation positions set by the sluggish axis from the beam positions required for the target contour are able to be compensated by the dynamic axes. In the case of FIG. 7A, the position deviations to be compensated are within the area of a beam region 215, which is plotted schematically for an irradiation position 211 in FIG. 7A. The position deviation at the time when the irradiation position 211 is adopted by the scanner device corresponds to a distance ΔXE if the energy beam should strike the corner E at this point in time. On account of the path length differences between the irradiation path 201 and the scanning path 203, it is possible to reduce the speed of the mechanical deflection in order to obtain a constant scanning speed. By way of example, the beam position running ahead by a distance ΔXV was indicated.

In general, a scanning speed along the irradiation path 201 can be chosen by adapting the speeds of the mechanical deflection and optical deflection. In this way, it is also possible to influence the energy input of the energy beam along the irradiation path 201.

Consequently, the aspects described herein can allow in particular the reduction or even avoidance of deceleration phases, acceleration phases, and adaptations in the energy of the energy beam required as a result. Consequently, it is also possible to reduce the outlay in the process development since, in particular, the energy in the energy beam should be adapted for every powder material type (grain size distribution, chemical composition).

By way of example, the corner E may be part of a protruding structure in the case of the additive manufacture of the component part 4 shown in FIG. 1. To further reduce the energy input into the corner, the exposure can further be modified with the aid of the optical deflection unit, as will be explained below in the context of FIG. 7B. Provided an angular structure to be formed has dimensions substantially within the range of instantaneous abrupt optical deflections, the angular contour can again be implemented by way of linear path segments 201A and 201B′ of the irradiation path 201. By way of example, the mechanical deflection can bring about a sequence of irradiation positions set by means of the scanner device, which are arranged on a curved scanning path 203. However, in the process, each of the path segments 201A and 201B′ is now scanned continuously, optionally with a varying scanning speed, in the direction of the corner E of the irradiation path (in general to a taper/tip of a component part to be formed). The path segments 201A and 201B′ are likewise examples of subsequences of beam positions which each comprise a plurality of beam positions. Accordingly, even the arrow tip of the path segment 201B′ was plotted at the corner E. By way of example, scanning can initially be carried out along the path segment 201A, with deviations of the mechanical deflection again being compensated for by the optical deflection. Once the corner E has been reached, there is a jump with the aid of the optical deflection device to the start of the path segment 201B′, and starting from there, there is renewed scanning in the direction of the corner E of the irradiation path 201.

In this way, solidification processes can in general be implemented from the region “with better heat dissipation” to a region “with poorer heat dissipation” (e.g., a tip in the structure of the component part 4 to be manufactured), which allows a risk of overheating to be further reduced. Attention is drawn to the fact that precisely the concepts for the division into a mechanical and an optical deflection proposed herein allow such a procedure to be advantageously implemented. The energy beam need not be deactivated in the process since the required jump is implemented virtually instantaneously, and so valuable time is not lost as a result of displacing the energy beam prior to carrying out the process “from the other side”.

FIG. 7C further elucidates how moreover the manufacture of an angular structure can be accelerated by increasing the radiated-in energy if the option of an instantaneous abrupt optical deflection is additionally used. That is to say, use can be made of an energy input by way of the energy beam (e.g., the power of a laser beam) which is above a limit value as is usually predetermined for a powder material type (grain size distribution, chemical composition of the powder material 2) in the case of continuous scanning with a beam diameter at a given scanning speed and, for example, as should be observed in the case of an irradiation according to the irradiation strategies elucidated in the context of FIGS. 7A and 7B.

To this end, like in FIG. 7C, two path segments 201A″ and 201B″ (which are linear in particular and together form an irradiation path corner (E)) are shown as examples of subsequences of beam positions 217. The subsequences are exposed point by point, that is to say at the beam positions 217, and from the inside to the outside, that is to say toward the corner E, at the same time. To this end, the energy beam can be alternately displaced to at least one beam position of the subsequence of a first of the irradiation path segments, for example path segment 201A″, and at least one beam position of the subsequence of a second of the irradiation path segments, for example path segment 201B″. For elucidation purposes, FIG. 7C specifies an exemplary sequence 1 to 10 with ten exemplary beam positions (with overlapping melt regions indicated in a circular fashion) along the path segments 201A″ and 201B″. The optical deflection must allow at least a jump from beam position 1 to beam position 2. In general, the displacement between the subsequences by way of the optical deflection can be implemented abruptly. The change in the mechanical deflection can be implemented continuously, optionally with a varying scanning speed. By way of example, the mechanical deflection can bring about a sequence of irradiation positions 211 set by means of the scanner device, which are arranged on a curved scanning path 203.

FIG. 8 shows a further example of a possible interaction between mechanical deflection and optical deflection when forming an irradiation path 301. The irradiation path 301 comprises a region of an abrupt curvature K, up to which the energy beam can be guided purely mechanically at a constant speed. Following the curvature K is enabled by activating the optical deflection which holds the energy beam on the irradiation path 301 while the scanning path 303 of the mechanical deflection by the scanner device sluggishly goes beyond the point of the curvature before it is returned, in accelerated fashion, to the irradiation path 301 in order to take over sole guidance of the energy beam again. In this case, the mechanical deflection brings about a sequence of irradiation positions set by the scanner device, which sequence is arranged on a curved scanning path 303 and scanned continuously, optionally with a varying scanning speed, with the curvature of the scanning path 303 being less than the curvature of the curved segment. In FIG. 8, an irradiation position 311, an associated beam region 315, and optical correction paths ΔX are shown in exemplary fashion.

FIGS. 9A and 9B explain the formation of irradiation paths in which a broadening of a “mechanical” scanning vector (scanning path) beyond a diameter of the energy beam is carried out with the aid of a lateral optical deflection. The broadening is indicated by strips 403′ and 503′ in FIGS. 9A and 9B, respectively. The strip 403′ or 503′ represents a region of a layer to be exposed, for example a section that forms a protrusion region of the component part during the manufacture.

For a given combinability of mechanical deflection and optical deflection, two strategies for processing protrusion regions while avoiding local overheating are explained in exemplary fashion below:

FIG. 9A shows a quasi-stationary exposure strategy, in which the irradiation path comprises a subsequence of beam positions whose positions are located within an associated beam region of the deflection device in the case of a mechanical deflection that has been fixed at an irradiation position within the work region. A scanner device positions the energy beam at an irradiation position 411A, which for example corresponds to a center position of a partial area T of a scanning vector to be exposed. Using an optical deflector of the optical deflection device, the energy beam then is successively directed at different beam positions 417 of the partial area T in order to expose these in a specified sequence during a predetermined duration. An exemplary sequence 1-2-3-4-5-6-7 . . . n when adopting the beam positions 417 to be adopted is indicated in FIG. 9A. In this sequence, adjacent points are not exposed directly in succession. In this case, the partial area T is limited in terms of the extents by the beam region 415 in relation to the irradiation position 411A. In the present case, the partial area T is smaller than the beam region 415. The subsequence of the beam positions on the partial area T is scanned by changing only the optical deflection during a fixed mechanical deflection.

With the object of an improved manufacturing process, the energy beam will only directly successively expose non-adjacent beam positions 417 where possible, as described above. There is no displacement of the irradiation position 411 (i.e., no movement of the scanner device) during the exposure of the partial area T by the fast deflection. Consequently, there is temporarily a static exposure situation in view of the mechanical deflection. Once the entire partial area T has been exposed, the scanner device is activated and a new irradiation position 411B is set such that an adjoining partial region of the strip 403′ can be exposed.

FIG. 9B shows an on-the-fly exposure, in which a mechanical deflection is carried out continuously and overlaid by an optical deflection. The scanner device guides the energy beam along a defined trajectory, the scanning path 503. The scanning path 503 may be a linear scanning vector—like in the example of FIG. 9B—or it may follow a given contour. At the same time as the mechanical scanning movement, the energy beam jumps to beam positions 517 which may be located, for example, to the right and left of, that is to say laterally to, the scanning path 503 and thereon by means of optical deflection. In this case, too, the energy beam will where possible only directly successively expose non-adjacent beam positions 517 in the process. An exemplary sequence 1-2-3-4-5 for adopting the beam positions 517 to be adopted is indicated in FIG. 9B.

According to the embodiments in FIGS. 7A to 9B for example, the scanner device can be controlled in such a way that the mechanical deflection positions the energy beam continuously/incrementally at a sequence of irradiation positions. At the same time, the deflection device is controlled in such a way that the energy beam successively adopts the beam positions of subsequences which partially or completely cover the beam region of the corresponding irradiation position 411, and in particular a given beam shape of the beam region (see the beam region 415 and the partial area T in FIG. 9A, for example).

In view of the various exemplary embodiments regarding the irradiation of beam positions, a person skilled in the art will further acknowledge that the deflection device can be controlled in such a way that the energy beam at an irradiation position of the plurality of irradiation positions is displaced to a plurality of beam positions within a beam region in order, during the production of a component part, to form a beam profile of the beam region to be irradiated. In the process, the energy beam can be abruptly displaced to the plurality of discrete beam positions of the beam profile to be irradiated. Further, the energy beam may skip spatially adjacent beam positions in the beam region in particular and in particular only adopt spatially non-adjacent beam positions in the beam region successively in time.

FIGS. 10A to 10D explain irradiation strategies for an additive manufacture of delicate structures, in which a detailed exposure of partial regions is only carried out by means of optical deflection.

For a fixed mechanical deflection, and in a manner similar to FIG. 9A, a subsequence of beam positions can form a line-up of parallel, in particular linear scanning vectors and a length of each of the scanning vectors can be less than or equal to an extent of the beam region of the deflection device in the direction of the respective scanning vector.

A number of short scanning vectors frequently arise within the irradiation plan of delicate component parts. Expressed differently, the irradiation path may comprise a plurality of subsequences of beam positions, the positions of which are located within a beam region of the deflection device in the case of a mechanical deflection that has been fixed within the work region at a respective irradiation position belonging to a subsequence.

When triggering the short vectors with a relatively sluggish mechanical scanner device, the exposure requires a high proportion of acceleration and deceleration paths (skywriting, scanner delay) between the individual short vectors. Consequently, this requires a high non-productive proportion of time during the exposure if the exposure is carried out only by the scanner device 7 of FIG. 1, for example. Further, a successive exposure of short vectors may lead to local overheating or (to avoid local overheating) process pauses may instead be enforced, the latter having to be provided for when using a mechanical deflection for delicate structures. The process pauses should be chosen in such a way that they ensure that a sufficient amount of heat can dissipate along the irradiation path.

Using the concepts, disclosed herein, of combining, e.g., a galvanometer scanner and an AOD, writing/exposing of delicate structures is only implemented using the optical deflection of the AOD. Expressed differently, each of the plurality of subsequences can be scanned solely by changing the optical deflection, with the mechanical deflection being fixed. Between the scanning of two subsequences of the plurality of subsequences, the mechanical deflection can be changed from one irradiation position to another irradiation position. This can reduce or avoid idle times and/or overheating.

FIGS. 10A to 10D show sketches for elucidating irradiation strategies for an additive manufacture of delicate structures. FIG. 10A shows an irradiation strategy for a tapering delicate structure F in a component part layer. For the exposure, the delicate structure is assigned a partial area T_M, within which the exposure is carried out exclusively along a group of long scanning vectors S_M, which are depicted using dashed lines. By way of example, the long scanning vectors S_M can be exposed/scanned purely by means of mechanical deflection of the laser beam, and in that case represent irradiation paths of the scanner device.

It is evident from FIGS. 10A to 10D that the delicate structure in the component part layer also forms a narrow, tapering partial area T_O. In the narrow partial area T_O, the delicate structure is tapered to a width that is smaller than the extent of a possible beam region 615 of the optical deflection apparatus. Exemplary beam regions 615 are indicated around irradiation positions 611 in FIG. 10A.

A change in the type of scanning can be implemented for these proportions, within the scope of which scanning is now implemented exclusively by means of optical deflection. For the narrow partial areas T_O of the component part layer of the delicate structure F, FIGS. 10A to 10D show short scanning vectors S_O. The short scanning vectors S_O are scanned only by means of optical deflection of the laser beam, to be precise in the case of
e.g., galvanometer scanner mirrors at rest (irradiation positions 611 in FIG. 10A) or
only slowly moving galvanometer scanner mirrors (scanning path 703 in FIG. 10B).

As a result of the fast optical deflection by means of the AOD, disadvantageous delay times when changing between short scanning vectors S_O are dispensed with.

Since a sequential exposure may lead to overheating on account of the short scanning vectors if the vicinity of a region previously exposed is irradiated prematurely by the energy beam, the exposure sequence of the individual short scanning vectors S_O in the partial area T_O may moreover be implemented in virtually any vector sequence. FIG. 10C elucidates vector sequences 1-2-3-4-5, 1′-2′-3′-4′-5′, 1″-2″-3″ for the case of a temporarily stationary mechanical deflection. Thus, for example, at least one short scanning vector S_O is always skipped in the three beam regions 815 which are able to be optically scanned about irradiation positions 811.

Further, a respective scanning direction has been indicated for the scanning vectors S_M and S_O, which is inverted in each case for successive scanning vectors (be they short or long).

Expressed differently, non-adjacent short scanning vectors S_O which always have a minimum spacing can be scanned with the aid of the optical fast deflection, and so the short scanning vectors S_O of the delicate structure F can be worked efficiently—without stopping the optical deflection.

FIG. 10D shows a further advantage of the flexibility of the optical deflection. Thus, the use of the optical deflection allows scanning to be always carried out in one direction. On account of the fast deflection within the beam region 915, empty travels required to this end are temporally of no consequence. By way of example, the scanning of the short scanning vectors S_O of the delicate structure F in the scanning direction can be directed, where possible, counter to a gas flow G guided over the work region 9, as a result of which a higher process quality can be attained, especially in the region of the delicate structure F.

The short scanning vectors S_O are likewise examples of subsequences of beam positions which each comprise a plurality of beam positions.

In view of the various exemplary embodiments for irradiating subsequences of beam positions, a person skilled in the art will acknowledge that if the dissipation of the energy input into the subsequences by means of the energy beam is considered, more particularly ensured, it is possible to determine a number of subsequences along the irradiation path and/or a number of beam positions in one of the subsequences and/or a spatial distance between successively adopted subsequences. In particular, it is possible to limit the amount of energy input into the subsequences by means of the energy beam or limit the irradiation duration.

The selection of energy and irradiation duration at a beam position depends, inter alia, on whether there is skipping between, e.g., two, three, or even more subsequences: By way of example, if only one beam position is skipped such that there might still be a thermal interaction, albeit a reduced thermal interaction, between the two subsequences and if there is only jumping back and forth between two subsequences, it may be possible to introduce twice as much energy per unit time into each of the subsequences (in comparison with continuous irradiation); an analogous statement applies if, for example, there is jumping between four subsequences (assuming the same irradiation time per beam position). Thus, close, thermally interacting subsequences may possibly also be irradiated if sufficient “thermal pauses” are installed between the exposures as a result of further exposure at different subsequences/beam positions. It is thermally relevant, inter alia, whether the energy/power introduced at a point during the manufacturing process is so much higher than the dissipated heat/power that a peak temperature that is too high is obtained, which for example may lead to discolorations, an unstable manufacturing process, or other problems.

Attention is drawn to the fact that the irradiation strategies disclosed herein may generally also comprise an irradiation path with a subsequence of beam positions which are adopted by a change in the mechanical deflection in the case of a fixed or varying optical deflection.

Further, in general, a speed at which a sequence of spatially adjacent beam positions is continuously scanned may be chosen independently of whether one of the beam positions of the sequence of spatially adjacent beam positions is adopted by changing the optical deflection and/or by changing the mechanical deflection. Within the scope of additive manufacturing, preferred speeds for such a continuously carried out scanning movement are in the range from one meter per second to a few meters per second—similar to a purely mechanical scanner device. In this case, the speed may be chosen specifically for the powder material type and the energy beam/laser beam type.

In view of a scanning of beam positions that is as uniform as possible, a target speed range is located, for example, in the range of a few percent (possibly up to ±10% and more) about a given speed for an irradiation situation (powder material type, energy beam/laser beam), which given speed was determined, for example, for laser beam parameters and powder material parameters present in each case.

If the option of abrupt homing in on non-adjacent beam positions is included and the energy of the energy beam is increased accordingly, a scanning speed related to the entire irradiation path may adopt correspondingly higher values, with a correspondingly increased manufacturing efficiency.

It is explicitly emphasized that all features disclosed in the description and/or the claims should be regarded as separate and independent of one another for the purpose of the original disclosure and likewise for the purpose of restricting the claimed invention independently of the combinations of features in the embodiments and/or the claims. It is explicitly stated that all range indications or indications of groups of units disclose any possible intermediate value or subgroup of units for the purpose of the original disclosure and likewise for the purpose of restricting the claimed invention, in particular also as a limit of a range indication.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for displacing a continuous energy beam along an irradiation path formed by a sequence of beam positions and provided to solidify a powder material in a powder layer within a work region of a manufacturing device, including the steps of:
emitting the continuous energy beam in a direction of the powder material so as to form a layer of a component part within the scope of an additive manufacturing method; and
displacing the energy beam within the work region by overlaying an optical deflection of the energy beam using of a deflection device and a mechanical deflection of the energy beam using of a scanner device, wherein
the mechanical deflection is configured to position the energy beam at a plurality of irradiation positions arranged within the work region and substantially spanning the work region, and
the optical deflection is configured to deflect the energy beam around each of the irradiation positions within a beam region of the deflection device onto at least one beam position of the sequence of beam positions,
wherein the optical deflection and the mechanical deflection are changed simultaneously or successively so as to scan the sequence of beam positions using the energy beam, further including:
controlling the deflection device and the scanner device such that the energy beam successively scans subsequences, each subsequence comprising at least one beam position of the sequence of beam positions, with the energy beam skipping a region between subsequent subsequences by way of an abrupt change of the optical deflection such that two spatially separated subsequences are successively adopted by the energy beam.

2. The method as claimed in claim 1, wherein at least one of
a number of subsequences along the irradiation path,
a number of beam positions in one of the subsequences, and
a spatial distance between successively adopted subsequences
are determined based on a dissipation of an energy introduced into the subsequences by the energy beam.

3. The method as claimed in claim 1, wherein the controlling of the deflection device and the scanner device is performed such that
adjacent beam positions of the irradiation path are not adopted successively in time.

4. The method as claimed in claim 1, wherein the deflection device comprises an optical material in a passage region provided for receiving the energy beam, the material having optical properties which are adjusted to bring about the optical deflection, and
wherein the deflection device comprises a crystal in order to bring about the optical deflection.

5. The method as claimed in claim 4, further comprising:
exciting an acoustic wave with an acoustic wavelength in the optical material for the purposes of forming an acousto-optic diffraction grating;
radiating the energy beam onto the passage region;
diffracting a majority of the energy beam into a first order of diffraction at a diffraction angle at the acousto-optic diffraction grating;
guiding the diffracted energy beam to a first of the beam positions; and
changing the optical deflection of the energy beam by changing the acoustic wavelength.

6. The method as claimed in claim 4, further comprising:
exciting an acoustic wave with at least two acoustic wavelengths in the optical material for the purposes of forming an acousto-optic diffraction grating;
radiating the energy beam onto the passage region;
diffracting a majority of the energy beam into a first order of diffraction at a diffraction angle at the acousto-optic diffraction grating; and
guiding the diffracted energy beam to at least one first of the beam positions and one second of the beam positions.

7. The method as claimed in claim 1, wherein spatially non-adjacent beam positions of the irradiation path are adopted successively in time and/or
the spaced apart subsequences are arranged spaced apart from one another in the work region by at least one diameter of the energy beam and/or
a region of the work region is skipped, the region being selected from the group consisting of a not yet irradiated region of the work region, a not to be irradiated region of the work region, and an already irradiated region of the work region.

8. The method as claimed in claim 1, wherein, while the scanner device is controlled such that the mechanical deflection positions the energy beam at an irradiation position, the deflection device is controlled such that the energy beam successively adopts the beam positions of subsequences which completely cover the beam region of the corresponding irradiation position.

9. The method as claimed in claim 1, wherein, while the scanner device is controlled such that the mechanical deflection positions the energy beam continuously at a sequence of irradiation positions, the deflection device is controlled such that the energy beam successively adopts the beam positions of subsequences which partially or completely cover the beam region of each corresponding irradiation position.

10. The method as claimed in claim 1, wherein the deflection device is controlled such that the energy beam at one irradiation position of the plurality of irradiation positions is displaced to a plurality of beam positions within a beam region in order to form a beam profile of the beam region during the production of a component part, and the energy beam is abruptly displaced to the plurality of discrete beam positions,
with the energy beam skipping spatially adjacent beam positions in the beam region.

11. The method as claimed in claim 10, further comprising:
radiating-in the energy beam by virtue of the scanner device being controlled in such a way that the energy beam is positioned along a subsequence of irradiation positions in accordance with a scanning path and the deflection device simultaneously being controlled in such a way that the energy beam jumps back and forth between beam positions of a two-dimensional arrangement of beam positions.

12. The method as claimed in claim 1, wherein the irradiation path has at least one irradiation zone, in which a plurality of subsequences of irradiation positions are defined in the form of adjacent, at least partially parallel scanning vectors, the method further comprising:
radiating-in the energy beam by controlling the scanner device in such a way that the irradiation position is displaced along a first scanning vector of the scanning vectors and controlling the deflection device simultaneously in such a way that the energy beam jumps back and forth between the first scanning vector of the scanning vectors and at least one further scanning vector of the scanning vectors.

13. The method as claimed in claim 1, further comprising:
radiating-in the energy beam by controlling the scanner device in such a way that the irradiation position is displaced along a subsequence of irradiation positions in accordance with a scanning direction and controlling the deflection device simultaneously in such a way that the energy beam jumps, in and counter to the scanning direction, between beam positions arranged along the subsequence.

14. The method as claimed in claim 1, wherein the irradiation path has at least two irradiation zones, each defining a plurality of subsequences of irradiation positions in the form of adjacent, at least partially parallel scanning vectors of a same length, wherein,
to displace the energy beam, the scanner device is controlled in such a way that the energy beam is positioned along a first scanning vector of the scanning vectors in a first of the irradiation zones and the deflection device simultaneously is controlled in such a way that the energy beam jumps back and forth between the first of the scanning vectors in the first of the irradiation zones and at least one further scanning vector of the scanning vectors of a further one of the irradiation zones.

15. The method as claimed in claim 1, wherein the irradiation path has at least one irradiation zone or delicate structure, in each of which a plurality of subsequences of irradiation positions are defined in the form of adjacent, at least partially parallel scanning vectors of the same or different length, wherein,
to displace the energy beam, the deflection device is controlled in such a way that the energy beam is positioned along a first scanning vector of the scanning vectors in the irradiation zone or delicate structure.

16. The method as claimed in claim 15, wherein, to displace the energy beam, the deflection device is controlled in such a way that the energy beam jumps back and forth between the first scanning vector and at least one further scanning vector of the scanning vectors and that the energy beam is positioned along the at least one further scanning vector.

17. A manufacturing device for additive manufacturing of a component part from a powder material provided within a work region, the manufacturing device comprising
a beam producing device configured to produce a continuous energy beam for irradiating the powder material,
a scanner device configured to mechanically deflect the energy beam to position the energy beam at a plurality of irradiation positions substantially spanning the work region,
a deflection device configured to optically deflect the energy beam around each of the irradiation positions within a beam region onto at least one beam position of the sequence of beam positions, and
a control device operatively connected to the scanner device and the deflection device and configured to control the deflection device and the scanner device such that the optical deflection and the mechanical deflection are changed simultaneously or successively in order to scan an irradiation path formed by a sequence of the beam positions by way of the continuous energy beam, with the irradiation path being provided for solidifying the powder material in a powder layer within the work region.

18. The manufacturing device as claimed in claim 17, wherein the control device is configured to control the deflection device
to abruptly displace the energy beam to a plurality of discrete beam positions and/or
to successively scan subsequences with the energy beam, the subsequences each comprising at least one beam position of the sequence of beam positions in the irradiation path, the energy beam skipping a region between subsequences by way of an abrupt change of the optical deflection such that spatially separated subsequences are successively adopted by the energy beam.

19. The manufacturing device as claimed in claim 17, wherein
the scanner device comprises at least one scanner that is displaceable relative to the work region,
the deflection device comprises at least one electro-optic deflector and/or acousto-optic deflector,
the deflection device comprises at least one acoustic-optic deflector with an optical material configured to produce acoustic waves in the optical material, and/or
the beam producing device is in the form of a continuous wave laser.
